(19) United States
(12) Patent Application Publication
(10) Pub. No.: US 2003/0033738 A1
(43) Pub. Date: Feb. 20, 2003

(54) Key ring

(76) Inventor: Lih-Yun Lii, Lu-Chou City (TW)

Correspondence Address: DAVID E. DOUGHERTY, DENNISON, SCHULTZ, & DOUGHERTY, 612 CRYSTAL SQUARE 4, 1745 JEFFERSON DAVIS HIGHWAY, ARLINGTON,, VA, 22202, US

(21) Appl. No.: 09/931,869

(22) Filed: Aug. 20, 2001

(51) Int. Cl. G02B 27/02

(52) U.S. Cl. 40/364

(57) ABSTRACT

A key ring includes a transparent glass plate and a light-emitting diode (LED) circuit board assembly capable of indicating an in-coming call, both of which being mounted in and between two covers, such that light-emitting diodes on the LED circuit board assembly are located immediately behind the glass plate. The light emitting diodes intermittently emit light beams when there is an in-coming call or a switch on the LED circuit board assembly is actuated, and the emitted light beams are directly projected onto the glass plate to shine and highlight patterns, words, zodiac signs or company names preformed on the glass plate.

### BACKGROUND OF THE INVENTION

The present invention relates to a key ring, and more particularly to a key ring having light emitting diodes to shine patterns, words, zodiac signs or company names preformed on a transparent glass plate to provide novel, unique and effective advertising effect.

The highly developed industrial technologies enable the production of articles having high quality and versatile functions to meet most people's requirements. That is, an article providing added value and being produced at low cost is particularly welcome among consumers. A key ring is a popular product and it must have novel functions other than holding keys to attract consumers.

### SUMMARY OF THE INVENTION

A primary object of the present invention is to provide a novel key ring that is capable of indicating an in-coming call and/or detecting a pinhole camera, and highlighting a desired logo and the like to serve as an effective advertising means.

Another object of the present invention is to provide a novel key ring that is capable of emitting light to serve as an auxiliary light source when a user opens a door in the dark.

To achieve the above and other objects, the key ring of the present invention mainly includes a transparent glass plate and a light-emitting diode (LED) circuit board assembly, both of which being mounted in and between two covers that are closed to each other, such that light-emitting diodes on the LED circuit board assembly are located immediately behind the glass plate. The LED circuit board assembly is configured to provide more than one function, such as indicating an in-coming call, detecting a pinhole camera, etc. The light emitting diodes intermittently emit light beams when an in-coming call or a pinhole camera is detected or a switch on the LED circuit board assembly is actuated, and the emitted light beams are directly projected onto the glass plate to shine and highlight patterns, words, zodiac signs or company names preformed on the glass plate.

### BRIEF DESCRIPTION OF THE DRAWINGS

The structure and the technical means adopted by the present invention to achieve the above and other objects can be best understood by referring to the following detailed description of the preferred embodiments and the accompanying drawings, wherein

FIG. 1 is an exploded perspective view of a key ring according to the present invention;

FIG. 2 is an assembled perspective view of FIG. 1;

FIG. 3 shows the position of an LED circuit board assembly relative to a glass plate included in the key ring of the present invention; and

FIGS. 4 and 5 illustrate two embodiments of the present invention.

### DETAILED DESCRIPTION OF THE PREFERRED EMBODIMENTS

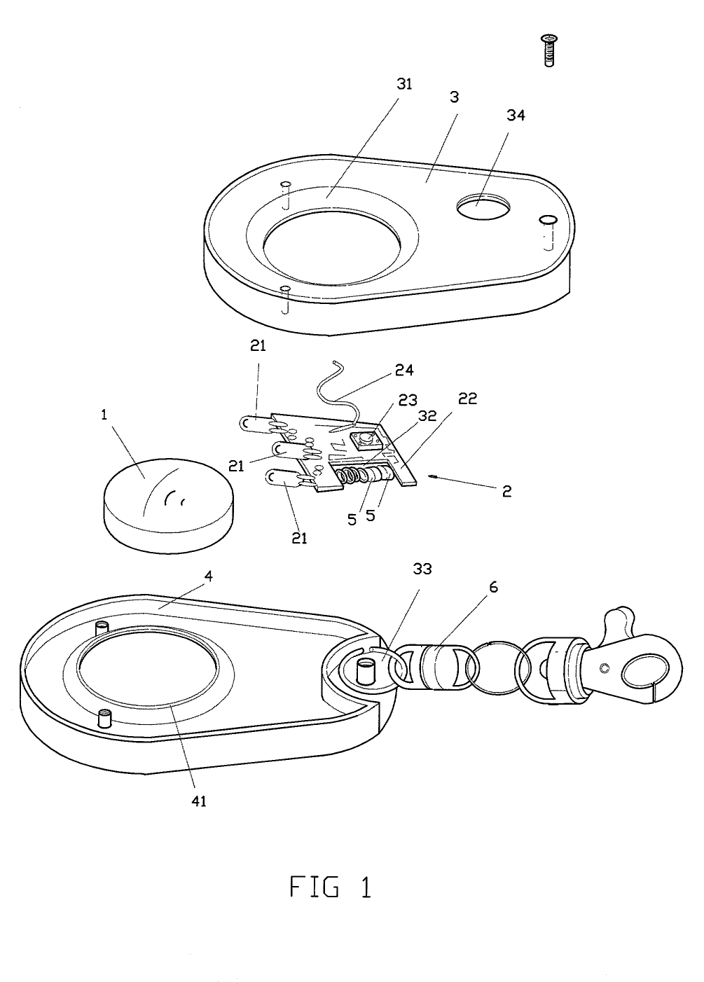

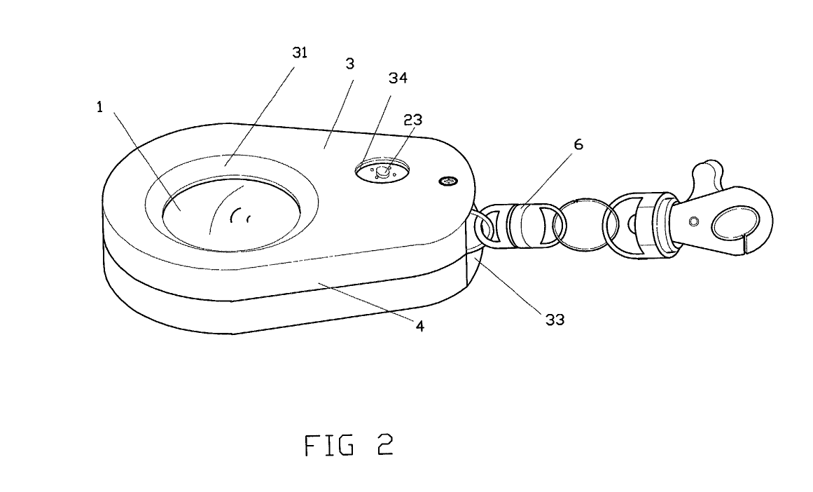

Please refer to FIGS. 1 and 2 that are exploded and assembled perspective views, respectively, of a key ring according to the present invention. As shown, the key ring mainly includes a transparent glass plate 1, a light-emitting diode (LED) circuit board assembly 2 having a function to indicate an in-coming call, two covers 3 and 4, and a plurality of batteries 5.

The transparent glass plate 1 may be in a geometrical shape, such as a square, a triangle, a circle, etc. Patterns, words, zodiac signs, company names, etc. may be provided on the glass plate 1 in advance by means of, for example, laser engraving.

The LED circuit board assembly 2 mainly includes a plurality of light-emitting diodes 21, a base 22, a switch 23, and an antenna 24. The light-emitting diodes 21 are configured to provide more than one function, such as indicating an in-coming call, detecting a pinhole camera, or flashing when the switch 23 is actuated. The functions of indicating an in-coming call and detecting a pinhole camera are known in the art and have been widely associated with the reception antenna of a mobile phone and many other communication apparatus. Since it is a known skill, it is not discussed in details herein.

The two covers 3, 4 are two shaped shells made of a thin material to define between them a space of a predetermined overall thickness when they are closed to each other. The two covers 3, 4 are respectively provided near a first end with a central through hole 31, 41 being sized and shaped corresponding to the transparent glass plate 1. The LED circuit board assembly 2 is received in the space between the two covers 3, 4 to locate near a second end of the covers 3, 4. One of the two covers, for example, the cover 3, is provided at a position corresponding to the switch 23 on the LED circuit board assembly 2 with an opening 34, so that the switch 23 is accessible via the opening 34. The base 22 is provided at a predetermined position with a battery space 32 for accommodating the batteries 5 therein to electrically connect to and supply power needed by the LED circuit board assembly 2. The covers 3, 4 are respectively provided at the second end with two recesses 33 that together provide a space for a key chain 6 to connect an end thereto.

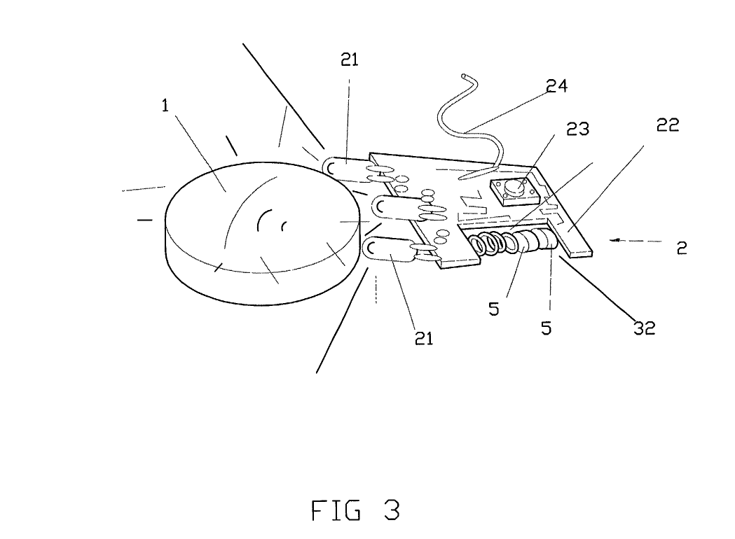

To assemble the key ring of the present invention, first set the transparent glass plate 1 between the two through holes 31, 41 of the two covers 3, 4, so that two side surfaces of the glass plate 1 are exposed from the through holes 31, 41. Then, fix the LED circuit board assembly 2 in the space between the covers 3, 4 adjacent to the glass plate 1, so that the light-emitting diodes 21 are located immediately behind the glass plate 1, as shown in FIG. 3, and the switch 23 is partially projected from the opening 34 to be conveniently pushed on or off, as shown in FIG. 1. The two covers 3, 4 are then fastened together by means of, for example, screws. Finally, the batteries 5 are mounted into the battery space 32.

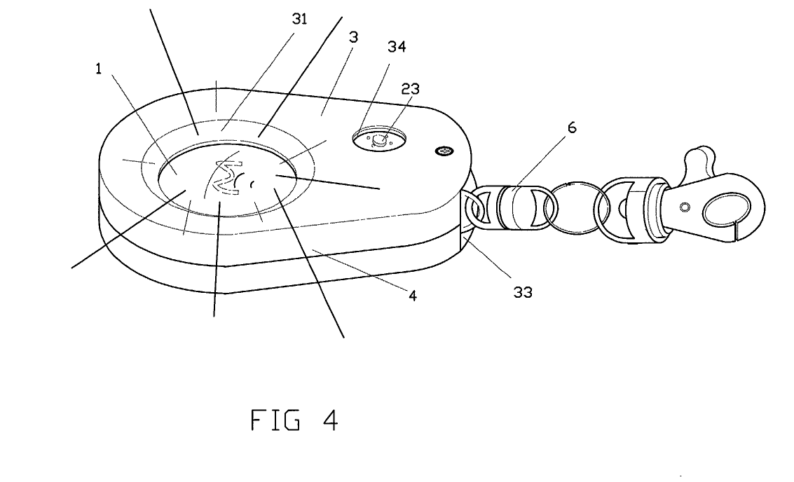

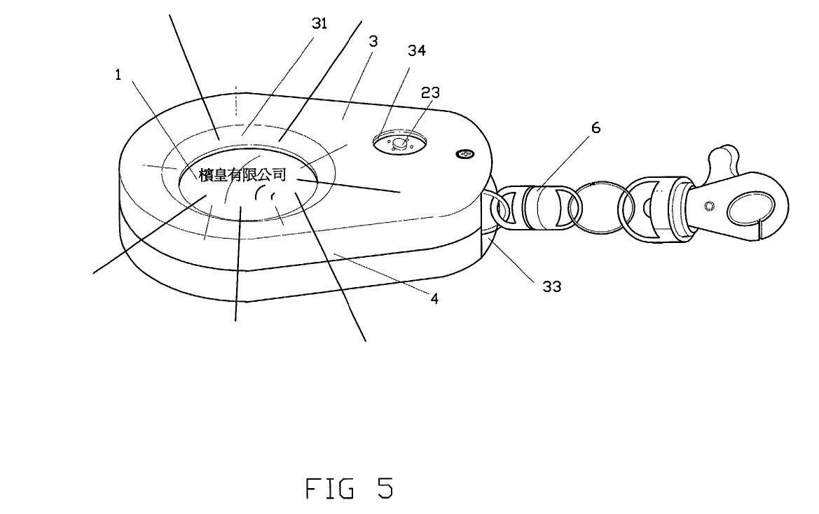

When the key ring of the present invention is in use, the light-emitting diodes 21 are turned on and emit light beams intermittently when an in-coming call from a mobile phone having a signal frequency preset in the LED circuit board assembly 2 is received, or a pinhole camera is detected, or the switch 23 is pushed. Light beams intermittently emitted by the light-emitting diodes 21 are directly projected onto the transparent glass plate 1 in front of the light-emitting diodes 21 to shine and highlight the patterns, words, zodiac signs or company names preformed on the glass plate 1 by means of laser engraving, making the key ring a novel and effective advertising means, as shown in FIGS. 4 and 5.

What is claimed is:

1. A key ring, comprising a transparent glass plate, a light-emitting diode (LED) circuit board assembly capable of indicating an in-coming call and/or detecting a pinhole camera, two covers, and a plurality of batteries; said LED circuit board assembly including a plurality of light-emitting diodes that intermittently emit light beams when a switch on said LED circuit board assembly is actuated, and said light beams emitted by said light-emitting diodes being directly projected onto said transparent glass plate to shine and highlight patterns, words, zodiac signs or company names preformed on said glass plate.

2. The key ring as claimed in claim 1, wherein said two covers are two shells made of a thin material to define between them a space of a predetermined overall thickness, and said two covers being separately provided near a first end with a central through hole having size and shape corresponding to those of said transparent glass plate in order to enclose said glass plate in and between said two through holes.

3. The key ring as claimed in claim 1, wherein said LED circuit board assembly are mounted in said space between said two covers near a second end of said covers with said light-emitting diodes on said LED circuit board assembly located immediately behind said transparent glass plate.

4. The key ring as claimed in claim 1, wherein said LED circuit board assembly includes a base that provides a battery space for mounting said batteries therein, so that said batteries are electrically connected to said LED circuit board assembly to provide power needed by said light-emitting diodes.

5. The key ring as claimed in claim 1, wherein said transparent glass plate may be in any geometrical shape, and said patterns, words, zodiac signs or company names being preformed on said glass plate by means of laser engraving.
